(19) United States
(12) Patent Application Publication
(10) Pub. No.: US 2026/0347732 A1
(43) Pub. Date: Nov. 5, 2026

(54) MILD UNIT DOSE LAUNDRY DETERGENT COMPOSITIONS WITH REDUCTION IN YELLOWING OVER TIME

(71) Applicant: Henkel AG & Co. KGaA, Duesseldorf (DE)

(72) Inventors: Daniel Thomas Piorkowski, Fairfield, CT (US); Sarah Anne Elliott, Trumbull, CT (US)

(73) Assignee: Henkel AG & Co. KGaA, Duesseldorf (DE)

(21) Appl. No.: 19/437,039

(22) Filed: Dec. 30, 2025

Related U.S. Application Data
(60) Provisional application No. 63/793,177, filed on Apr. 23, 2025.

(51) Int. Cl. C11D 17/04; C11D 1/29; C11D 1/72; C11D 1/83; C11D 3/04; C11D 3/386

(52) U.S. Cl. CPC C11D 17/043; C11D 1/29; C11D 1/72; C11D 1/83; C11D 3/044; C11D 3/38618; C11D 3/38636

(57) ABSTRACT

The present disclosure provides a unit dose product comprising a mild liquid detergent composition comprising surfactants, solvents, base, and optionally enzymes, with reduced yellowing while maintaining mildness and good cleaning performance. The liquid detergent composition is substantially free of monoethanolamine, sodium sulfite, and linear alkyl benzene sulfonates. The unit dose product exhibits a Pantone color ranking of 1 or less after one week at a temperature of of about 40 °F.

### BACKGROUND

Packaging detergent compositions in unit dose products is a preferred consumer product for use in laundry applications. Such unit dose products have several advantages, including convenience of use and dispensing, pleasing aesthetics, lower cost per use, and minimized skin contact with potentially irritating cleaning compositions. However, formulating detergent compositions to be packaged in unit dose film pouches presents additional challenges. In particular, unit dose products comprising clear or transparent liquid compositions have a tendency to exhibit discoloration over time, resulting in an undesirable yellow tint of the unit dose product.

There is a need for a unit dose product comprising a detergent composition that can effectively clean textiles while retaining mildness and limiting yellowing over time.

### BRIEF SUMMARY

The present disclosure relates to a unit dose product comprising a water-soluble film material and a liquid detergent, the liquid detergent composition comprising: about 4 wt % to about 30 wt % of a surfactant comprising a non-ionic surfactant and/or an anionic surfactant; a non-aqueous solvent; sodium hydroxide; a fatty acid; and water, wherein when the anionic surfactant is present, the non-ionic and anionic surfactant are present in a ratio of about 4:1 to about 9:1, wherein the liquid detergent composition is substantially free of monoethanolamine, sodium sulfite, and linear alkyl benzene sulfonate, wherein the liquid detergent composition is encapsulated in the water-soluble film material, and wherein the unit dose product exhibits a Pantone color ranking of 1 or less after one week at a temperature of about 40 °F. The present disclosure further relates to a unit dose product comprising a water-soluble film material and a liquid detergent composition, the liquid detergent composition comprising: about 25 wt % to about 30 wt % of a surfactant comprising a non-ionic surfactant and an anionic surfactant in a ratio of about 4:1 to about 9:1; about 45 wt % to about 50 wt % of a non-aqueous solvent selected from the group consisting of glycerin, ethanol, polyethylene glycol, and combinations thereof; about 1 wt % to about 2 wt % of sodium hydroxide; about 5 wt % to about 7 wt % of a fatty acid; and water, wherein the liquid detergent composition is substantially free of monoethanolamine, sodium sulfite, and linear alkyl benzene sulfonate, wherein the liquid detergent composition is encapsulated in the water-soluble film material, and wherein the unit dose product exhibits a Pantone color ranking of 1 or less after one week at a temperature of about 40 °F.

In some aspects, the liquid detergent composition comprises a non-ionic surfactant and an anionic surfactant.

In some aspects, the non-ionic surfactant is an alcohol ethoxylate and the anionic surfactant is an alkyl ether sulfate. In some aspects, the alcohol ethoxylate comprises the formula R¹-(EO)ₙ—OH, wherein R¹ is a C₁₂-C₁₈ alkyl group, EO is ethoxylate, and n is an integer of moles from 1 to 15, and the alkyl ether sulfate is sodium lauryl ether sulfate.

In some aspects, the non-aqueous solvent is selected from the group consisting of glycerin, ethanol, polyethylene glycol, and combinations thereof.

In some aspects, the fatty acid is palm kernel fatty acid.

In some aspects, the liquid detergent formulation further comprises at least one additive selected from one or more enzymes, a chelating agent, a polymer, a salt, a dye, a fragrance, an opacifier, a bittering agent, and combinations thereof.

In some aspects, the liquid detergent formulation further comprises one or more enzymes, a chelating agent, and a bittering agent.

In some aspects, the one or more enzymes comprise a protease and a mannase, the chelating agent is iminodisuccinic acid, and the bittering agent is bitrex.

In some aspects, the water-soluble film comprises a bittering agent.

In some aspects, the unit dose product exhibits a Pantone color ranking of 2 or less after one week of being stored at a temperature of about 75 °F.

In some aspects, the unit dose product exhibits a Pantone color ranking of 3 or less after one week of being stored at a temperature of about 105 °F.

In some aspects, the unit dose product comprises about 15 to about 24 grams of the liquid detergent composition.

In some aspects, the present disclosure relates to a method of preparing the liquid detergent composition of the unit dose product disclosed herein comprising adding the fatty acid to the surfactant and/or the non-aqueous solvent before adding the sodium hydroxide.

### BRIEF DESCRIPTION OF THE DRAWING/FIGURE

The patent or application file contains at least one drawing executed in color. Copies of this patent or patent application publication with color drawing(s) will be provided by the Office upon request and payment of the necessary fee.

FIG. 1 is a photograph of unit dose 1A compared to unit dose 2A at time point 0.

FIG. 2 is a photograph of unit doses 1B-D and 2B-D after being stored for 1 week at 40 °F (1B and 2B), 75 °F (1C and 2C), and 105 °F (1D and 2D), respectively.

FIG. 3 is the Pantone color scale used to score the unit dose products. The Pantone color scale shows the specific Pantone color number rated on a scale of 1 to 10, with 10 being the most yellow.

### DETAILED DESCRIPTION

The present disclosure relates to a unit dose product comprising a water-soluble film material and a liquid detergent, the liquid detergent composition comprising: about 4 wt % to about 30 wt % of a surfactant comprising a non-ionic surfactant and/or an anionic surfactant; a non-aqueous solvent; sodium hydroxide; a fatty acid; and water, wherein when the anionic surfactant is present, the non-ionic and anionic surfactant are present in a ratio of about 4:1 to about 9:1, wherein the liquid detergent composition is substantially free of monoethanolamine, sodium sulfite, and linear alkyl benzene sulfonate, wherein the liquid detergent composition is encapsulated in the water-soluble film material, and wherein the unit dose product exhibits a Pantone color ranking of 1 or less after one week at a temperature of about 40 °F. The present disclosure further relates to a unit dose product comprising a water-soluble film material and a liquid detergent composition, the liquid detergent composition comprising: about 25 wt % to about 30 wt % of a surfactant comprising a non-ionic surfactant and an anionic surfactant in a ratio of about 4:1 to about 9:1; about 45 wt % to about 50 wt % of a non-aqueous solvent selected from the group consisting of glycerin, ethanol, polyethylene glycol, and combinations thereof; about 1 wt % to about 2 wt % of sodium hydroxide; about 5 wt % to about 7 wt % of a fatty acid; and water, wherein the liquid detergent composition is substantially free of monoethanolamine, sodium sulfite, and linear alkyl benzene sulfonate, wherein the liquid detergent composition is encapsulated in the water-soluble film material, and wherein the unit dose product exhibits a Pantone color ranking of 1 or less after one week at a temperature of about 40 °F, and methods of making the same.

Non-limiting examples of the various aspects are shown in the present disclosure.

### DEFINITIONS

In order that the present disclosure can be more readily understood, certain terms are first defined. Additional definitions are set forth throughout the detailed disclosure.

All of the various aspects, embodiments, and options disclosed herein can be combined in any and all variants unless otherwise specified. Terms in this application control in the event of a conflict with a patent or publication term that is incorporated by reference.

As used herein, “a,” “an,” or “the” means one or more unless otherwise specified.

Furthermore, “and/or,” where used herein, is to be taken as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following aspects: A, B, and C; A, B, or C; A or C; A or B; B or C; A and C; A and B; B and C; A (alone); B (alone); and C (alone).

Open terms such as “include,” “including,” “contain,” “containing” and the like mean “comprising.” The term “or” can be conjunctive or disjunctive.

It is understood that wherever aspects are described herein with the language “comprising,” otherwise analogous aspects described in terms of “consisting of” and/or “consisting essentially of” are also provided.

Some inventive embodiments contemplate numerical ranges. Every numerical range provided herein includes the range endpoints as individual inventive embodiments. When a numerical range is provided, all individual values and sub-ranges therein are present as if explicitly written out.

The term “about” includes the recited number ±10%. For example, “about 10” means 9 to 11.

The phrase “substantially free of” means that a composition contains little to none of the specified ingredient/component, such as less than about 5 wt %, less than about 4 wt %, less than about 3 wt %, less than about 2 wt %, less than about 1 wt %, less than about 0.5 wt %, less than about 0.3 wt %, less than about 0.2 wt %, less than about 0.1 wt %, or about 0 wt % of the specified ingredient.

As used herein, the “%” described in the present application refers to the weight percentage unless otherwise indicated.

The term “at least” prior to a number or series of numbers is understood to include the number adjacent to the term “at least,” and all subsequent numbers or integers that could logically be included, as clear from context. For example, “at least one enzyme” means that 1, 2, 3, or more enzymes are included in the detergent composition. When at least is present before a series of numbers or a range, it is understood that “at least” can modify each of the numbers in the series or range. “At least” is also not limited to integers (e.g., “at least 5%” includes 5.0%, 5.1%, 5.18% without consideration of the number of significant figures).

Unless states otherwise, the term “by weight of the composition” refers to a composition of a final product derived from a process, unless otherwise defined.

The terms “process” and “method” can be used interchangeably.

The terms “alkoxylate” or “alkoxylated” as used in the present application means: the presence of an polyaliphatic ether moiety in a compound, such as ethoxylate (—CH₂CH₂O—) or propoxylate (—CH(CH₃)CH₂O—). A polyethoxylate is multiple repeat units of ethoxylate ((—CH₂CH₂O—)ₙ), and a polypropoxylate is multiple repeat units of propoxylate ((—CH(CH₃)CH₂O—)ₘ). The subscripts “n” and “m” are the same or different and each is an integer of 1 to 100 (e.g., 1 to 90, 1 to 80, 1 to 70, 1 to 60, 1 to 50, 1 to 40, 1 to 30, 1 to 20, 1 to 15, 1 to 14, 1 to 13, 1 to 13, 1 to 12, 1 to 11, 1 to 10, 1 to 9, 1 to 8, 1 to 7, 1 to 6, 1 to 5, or 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100).

The terms “ethoxylate” or “ethoxylated” as used in the present application means the presence of multiple repeat units of ethoxylate ((—CH₂CH₂O—)ₙ). The subscript “n” is an integer of 1 to 100 (e.g., 1 to 90, 1 to 80, 1 to 70, 1 to 60, 1 to 50, 1 to 40, 1 to 30, 1 to 20, 1 to 15, 1 to 14, 1 to 13, 1 to 13, 1 to 12, 1 to 11, 1 to 10, 1 to 9, 1 to 8, 1 to 7, 1 to 6, 1 to 5, or 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100).

The term “yellowing” as used in the present application refers to a visible yellow discoloration such as a yellow hue or yellow tint of the liquid detergent formulation.

The term “Pantone color scale” as used in the present application refers to a color order system of varying shades of yellow ranked on a scale of 1 to 10, with 10 being the most yellow. Each number, 1 through 10, is associated with a specific shade of yellow, corresponding to a unique Pantone number. The Pantone color scale ranking is defined as follows: 1=Pantone 1205 C; 2=Pantone 100 C; 3=Pantone 120 C; 4=Pantone 113 C; 5=Pantone 114 C; 6=Pantone 106 C; 7=Pantone 107 C; 8=Pantone 101 C; 9=Pantone 121 C; and 10=Pantone 115 C.

The term “Zein score” or “Zein number” as used in the present application refers to a score or number measured using a Zein test (see, e.g., U.S. 2018/0016523). A Zein test determines the extent of denaturation of Zein corn protein after exposure to a surfactant for a given period of time. Generally, the higher the Zein score, the greater the skin irritation potential.

In some aspects, the detergent compositions described herein have a Zein score of less than about 2% dissolved zein when tested at a 3% dilution. In other aspects the detergent compositions described herein have a Zein score of less than 1% dissolved zein when tested at a 3% dilution. The protocol can also be run on a detergent composition tested at a 10% dilution. In other aspects, the detergent compositions described herein at a 3% dilution (or a 10% dilution) have a Zein score of from about 0.01% to about 2%, from about 0.01% to about 1.75%, about 0.01% to about 1.5%, or about 0.01% to about 1.25%, or about 0.01% to about 1% dissolved zein.

### Detergent Composition

The present disclosure relates to a unit dose product comprising a water-soluble film material and a liquid detergent, the liquid detergent composition comprising: about 4 wt % to about 30 wt % of a surfactant comprising a non-ionic surfactant and/or an anionic surfactant; a non-aqueous solvent; sodium hydroxide; a fatty acid; and water, wherein when the anionic surfactant is present, the non-ionic and anionic surfactant are present in a ratio of about 4:1 to about 9:1, wherein the liquid detergent composition is substantially free of monoethanolamine, sodium sulfite, and linear alkyl benzene sulfonate, and wherein the unit dose product exhibits a Pantone color ranking of 1 or less after one week at a temperature of about 40 °F. The present disclosure further relates to a unit dose product comprising a water-soluble film material and a liquid detergent composition, the liquid detergent composition comprising: about 25 wt % to about 30 wt % of a surfactant comprising a non-ionic surfactant and an anionic surfactant in a ratio of about 4:1 to about 9:1; about 45 wt % to about 50 wt % of a non-aqueous solvent selected from the group consisting of glycerin, ethanol, polyethylene glycol, and combinations thereof; about 1 wt % to about 2 wt % of sodium hydroxide; about 5 wt % to about 7 wt % of a fatty acid; and water, wherein the non-ionic surfactant and anionic are present in a ratio of about 4:1 to about 9:1, wherein the liquid detergent composition is substantially free of monoethanolamine, sodium sulfite, and linear alkyl benzene sulfonate, and wherein the unit dose product exhibits a Pantone color ranking of 1 or less after one week at a temperature of about 40 °F.

Mildness is a significant consumer need and driver for laundry detergent purchase. There are several methods to measure the skin irritancy potential of a surfactant composition, such as the testing methods as described in U.S. 2018/0016523, the entire disclosure of which is incorporated herein by reference. These tests include Zein, Corneosufametry, and Cytokine testing, which can be used to determine the mildness of a detergent for consumers.

It was discovered that a mild composition (i.e., a composition with a low Zein score) could be provided with a detergent composition comprising mild surfactants while reducing undesired yellowing. In some aspects, the detergent composition has a Zein score that is not more than 2% dissolved zein when tested on a 10% dilution of the detergent composition when measured in accordance with the method set forth in U.S. 2018/0016523. In some aspects, the detergent composition has a Zein score of not more than 2% dissolved zein when tested on a 10% dilution. In some aspects, the detergent composition has a Zein score of not more than 1% dissolved zein when tested on a 10% dilution. In other aspects, the detergent composition has a Zein score of from about 0.01% to 2%, from about 0.01% to about 1.75%, about 0.01% to about 1.5%, or about 0.01% to about 1.25%, or about 0.01% to about 1% dissolved zein, when measured at a 10% dilution. In some aspects, the detergent composition has a Zein score of about 0.6 dissolved zein, when measured at a 10% dilution.

In some aspects, mildness of the detergent composition is controlled by the use of surfactants, solvents, bases, and optionally enzymes in varying amounts to improve mildness while maintaining stain removal performance and reducing undesired yellowing.

As commercial consumer products, unit dose liquid detergent products are usually stored and used over a period of time and their appearance and cleaning properties should remain stable for at least their shelf life. Instabilities of liquid detergent compositions comprised in unit dose packs can include visible changes such as phase separation, particulate formation, crystallization, discoloration, as well as chemical changes that result in diminished cleaning performance. In particular, clear or transparent liquid detergent compositions have a tendency to exhibit discoloration over time, resulting in a yellow tint of the liquid composition. For consumer acceptability, it is important to minimize yellowing to maintain aesthetically pleasing unit dose packs.

In some aspects, the unit dose product is transparent, where light can be transmitted through the liquid such that objects behind the liquid can be clearly seen. In some aspects, the unit dose product exhibits a Pantone color ranking of 1 or less (e.g. 0 or 1) after one week at a temperature of about 40 °F. In some aspects, the unit dose product exhibits a Pantone color ranking of 2 or less (e.g., 0, 1, or 2) after one week at a temperature of about 75 °F. In some aspects, the unit dose product exhibits a Pantone color ranking of 3 or less (e.g., 0, 1, 2, or 3) after one week at a temperature of about 105 °C.

It was surprisingly found that the use of sodium hydroxide (NaOH) in the liquid detergent composition was able to significantly reduce yellowing of the unit dose product over time while maintaining mildness and good cleaning performance. In some aspects, the liquid detergent composition is substantially free of monoethanolamine. In some aspects, the liquid detergent composition is substantially free of monoethanolamine and sodium sulfite. In some aspects, the liquid detergent composition comprises NaOH. In some aspects, the liquid detergent composition comprises a 50% NaOH solution.

In some aspects, the detergent composition comprises from about 1 wt % to about 5 wt % of a base (NaOH or 50% NaOH solution). For example, the liquid detergent composition can comprise NaOH or 50% NaOH solution in an amount from about 1 wt % to about 4.5 wt %, from about 1 wt % to about 4 wt %, from about 1 wt % to about 3.5 wt %, from about 1 wt % to about 3 wt %, from about 1 wt % to about 2.5 wt %, from about 1 wt % to about 2 wt %, from about 1 wt % to about 1.5 wt %, about 1 wt %, about 1.5 wt %, about 2 wt %, about 2.5 wt %, about 3 wt %, about 3.5 wt %, about 4 wt %, about 4.5 wt %, or about 5 wt %, of the total weight of the detergent composition. In some aspects, the detergent composition comprises from about 1 wt % to about 2 wt % of NaOH. In some aspects, the detergent composition comprises about 1.3 wt % of NaOH.

In some aspects, the liquid detergent composition comprises water in any amount that is sufficient to bring the total weight of the composition to 100 wt % (q.s.).

In some aspects, the detergent composition can have a pH of about 6 to about 12 (e.g., about 6 to about 12, about 6.5 to about 12, about 7 to about 12, about 7.5 to 12, about 8 to about 12, about 8.5 to 12, about 9 to about 12, about 9.5 to about 12, about 10 to about 12, about 10.5 to about 12, about 11 to about 12, about 11.5 to about 12, about 6.5 to about 11, about 7 to about 11, about 7.5 to about 11, about 8 to about 11, about 8.5 to about 11, about 9 to about 11, about 9.5 to about 11, about 10 to about 11, about 6.5 to about 10, about 7 to about 10, about 7.5 to about 10, about 8 to about 10, about 8.5 to about 10, about 9 to about 10, about 9.5 to about 10, about 6 to about 9, about 7 to about 9, about 7.5 to about 9, about 8 to about 9, about 8.5 to about 9). In some aspects, the detergent composition has a pH of about 6, about 6.5, about 7.1, about 7.2, about 7.3, about 7.4, about 7.5, about 7.6, about 7.7, about 7.8, about 7.9, about 8, about 8.1, about 8.2, about 8.3, about 8.4, about 8.5, about 8.6, about 8.7, about 8.8, about 8.9, about 9, about 9.1, about 9.2, about 9.3, about 9.4, about 9.5, about 9.6, about 9.7, about 9.8, about 9.9, about 10, about 10.1, about 10.2, about 10.3, about 10.4, about 10.5, about 10.6, about 10.7, about 10.8, about 10.9, about 11.1, about 11.2, about 11.3, about 11.4, about 11.5, about 11.6, about 11.7, about 11.8, about 11.9, or about 12. In some aspects, the detergent composition has a pH of about 6 to about 9. In some aspects, the detergent composition has a pH of about 7 to about 8.5.

The detergent composition comprises a non-aqueous solvent in addition to water. The non-aqueous solvent can comprise glycerin, ethanol, polyethylene glycol, and combinations thereof.

In some aspects, the non-aqueous solvent comprises polyethylene glycol (PEG), which can have the structure:

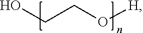

wherein n is an integer from 1 to 25 (e.g., 1 to 24, 1 to 23, 1 to 22, 1 to 21, 1 to 20, 1 to 18, 1 to 15, 1 to 12, 1 to 10, 2 to 25, 2 to 24 to 2 to 23, 2 to 22, 2 to 21, 2 to 20, 2 to 18, 2 to 15, 2 to 12, 2 to 10, 4 to 25, 4 to 23, 4 to 20, 4 to 18, 4 to 15, 4 to 12, 4 to 10, 7 to 25, 7 to 23, 7 to 20, 7 to 18, 7 to 15, 7 to 12, 7 to 10, 9 to 25, 9 to 23, 9 to 20, 9 to 18, 9 to 15, 9 to 12, etc.). In some aspects, n can be 1, 2, 3, 4, 5, 6, 7, 8, 9, 10, 11, 12, 13, 14, 15, 16, 17, 18, 19, 20, 21, 22, 23, 24, or 25.

In some aspects, the PEG has a molecular weight (including a number average molecular weight) of about 60 to about 1500 g/mol (e.g., about 60 to about 1200 g/mol, about 60 to about 1000 g/mol, about 100 to about 1500 g/mol, about 100 to about 1200 g/mol, about 100 to about 1000 g/mol, about 200 to about 1500 g/mol, about 200 to about 1200 g/mol, about 200 to about 1000 g/mol, about 300 to about 1500 g/mol, about 300 to about 1200 g/mol, about 300 to about 1000 g/mol, about 400 to about 1500 g/mol, about 400 to about 1200 g/mol, about 400 to about 1000 g/mol, about 200 g/mol, about 400 g/mol, about 600 g/mol, about 800 g/mol, or about 1000 g/mol).

In some aspects, the non-aqueous solvent comprises PEG in an amount of about 20 wt % to about 25 wt %. In some aspects, the non-aqueous solvent comprises PEG in an amount of about 20 wt % to about 25 wt %. For example, the non-aqeuous solvent can comprise PEG in an amount of from about 20 wt % to about 24.5 wt %, from about 20 wt % to about 24 wt %, from about 20 wt % to about 23.5 wt %, from about 20 wt % to about 23 wt %, from about 20 wt % to about 22.5 wt %, from about 20 wt % to about 22 wt %, from about 20 wt % to about 21.5 wt %, from about 20 wt % to about 21 wt %, about 20 wt %, about 21 wt %, about 22 wt %, about 23 wt %, about 24 wt %, or about 25 wt %, of the total weight of the liquid detergent composition. In some aspects, the detergent composition comprises about 23 wt % of PEG 400. In some aspects, the detergent composition comprises about 23 wt % of PEG 200. In some aspects, the detergent composition comprises about 23 wt % of PEG 1000.

In some aspects, the non-aqueous further comprises an alcohol (e.g., a C₁₋₄ alcohol), a polyol (e.g., a diol, a triol, or higher), or a combination thereof. Suitable examples of an alcohol and polyol include, e.g., ethanol, n-propanol, isopropanol, ethylene glycol, diethylene glycol, triethylene glycol, diethylene glycol monobutyl ether, propylene glycol, dipropylene glycol, tripropylene glycol, dipropylene glycol monobutyl ether, 1,3-butylene glycol, 1,4-butylene glycol, 1-(1-butoxy-2-propoxy)-2-propanol, 2-methyl-2,4-pentanediol, 1,5-pentanediol, 1,6-hexanediol, or a combination thereof.

In some aspects, the non-aqueous solvent comprises ethanol in an amount of about 1 wt % to about 5 wt %. For example, the non-aqueous solvent can comprise ethanol in an amount of from about 1 wt % to about 4.5 wt %, from about 1 wt % to about 4 wt %, from about 1 wt % to about 3.5 wt %, from about 1 wt % to about 3 wt %, from about 1 wt % to about 2.5 wt %, from about 1 wt % to about 2 wt %, from about 1 wt % to about 1.5 wt %, about 1 wt %, about 1.5 wt %, about 2 wt %, about 2.5 wt %, about 3 wt %, about 3.5 wt %, about 4 wt %, about 4.5 wt %, or about 5 wt %, of the total weight of the detergent composition. In some aspects, the detergent composition comprises about 3 wt % of ethanol.

In some aspects, the non-aqueous solvent further comprises glycerin. In some aspects, the non-aqueous solvent comprises glycerin in an amount of about 20 wt % to about 25 wt %. For example, the non-aqeuous solvent can comprise glycerin in an amount of from about 20 wt % to about 24.5 wt %, from about 20 wt % to about 24 wt %, from about 20 wt % to about 23.5 wt %, from about 20 wt % to about 23 wt %, from about 20 wt % to about 22.5 wt %, from about 20 wt % to about 22 wt %, from about 20 wt % to about 21.5 wt %, from about 20 wt % to about 21 wt %, about 20 wt %, about 21 wt %, about 22 wt %, about 23 wt %, about 24 wt %, or about 25 wt %, of the total weight of the liquid detergent composition. In some aspects, the detergent composition comprises about 23 wt % of glycerin.

In some aspects, the non-aqueous solvent comprises polyethylene glycol, glycerin, and ethanol.

In some aspects, the non-aqueous solvent comprises about 35 to about 55 wt % of non-aqueous solvent comprising polyethylene glycol, ethanol, and glycerin. For example, the total non-aqueous solvent content can be present in an amount from about 35 wt % to about 55 wt %, about 38 wt % to about 53 wt %, about 38 wt % to about 51 wt %, about 38 wt % to about 50 wt %, about 38 wt % to about 48 wt %, about 40 wt % to about 55 wt %, about 40 wt % to about 53 wt %, about 40 wt % to about 51 wt %, about 40 wt % to about 50 wt %, about 42 wt % to about 55 wt %, about 42 wt % to about 53 wt %, about 42 wt % to about 51 wt %, about 42 wt % to about 50 wt %, about 45 wt % to about 55 wt %, about 45 wt % to about 53 wt %, about 45 wt % to about 51 wt %, about 45 wt % to about 50 wt %, about 55 wt %, about 54 wt %, about 53 wt %, about 52 wt %, about 51 wt %, about 50 wt %, about 49 wt %, about 48 wt %, about 47 wt %, about 46 wt %, about 45 wt %, about 44 wt %, about 43 wt %, about 42 wt %, about 41 wt %, about 40 wt %, about 39 wt %, about 38 wt %, about 37 wt %, about 36 wt %, or about 35 wt % of the total weight of the composition. In some aspects, the detergent composition comprises about 40 wt % to about 50 wt % of non-aqueous solvent. In some aspects, the detergent composition comprises about 45 wt % to about 50 wt % of non-aqueous solvent.

In some aspects, the liquid detergent composition comprises an anionic surfactant, a cationic surfactant, a zwitterionic surfactant, a nonionic surfactant, or a combination thereof. In some aspects, the detergent composition comprises an anionic surfactant and a nonionic surfactant.

The anionic surfactant comprises a hydrophobic tail group (e.g., a linear aliphatic chain) and an anionic hydrophilic head group. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl), alkyl, or fluoro (e.g., perfluorinated). The anionic hydrophilic group can be, for example, a sulfate (—OSO₃⁻), sulfonate (—SO₃⁻), a phosphate (—OPO₃³⁻), a carboxylate (—C(O)O⁻), or the conjugate base of an organic acid. In some aspects, polyethylene glycol repeat units designated as “ether” can be disposed between the hydrophobic tail group (e.g., a fatty group) and hydrophilic head group.

In some aspects, the anionic surfactant comprises an alkyl sulfate, an alkyl sulfonate, a fatty acid salt, a bile acid salt, a glutamic acid salt, a cholic acid salt, a carboxylic poly(ethylene glycol) ether, a taurate, or a combination thereof. Typically, the salt will be a Group I (e.g., lithium, sodium, potassium, etc.).

Examples of an alkyl sulfate include, e.g., a fatty sulfate (e.g., octylsulfate, decyl sulfate, lauryl (dodecyl) sulfate, myristyl sulfate), dioctyl sodium sulfosuccinate, and an alkyl ether sulfate (AES)).

In some aspects, the anionic surfactant comprises an alkyl ether sulfate (AES). In general, the AES will have the structure R⁴—O-(EO)ₙSO₃⁻X⁺, in which R⁴ is a C₈-C₁₈ alkyl group (linear or branched), EO is polyethoxylate, n is typically 1 to 8 (e.g., 1, 2, 3, 4, 5, 6, 7, or 8), and X⁺ is a cation that balances the charge of the sulfonate. The C₈-C₁₈ alkyl group is an alkyl comprising 8 to 18 carbons (e.g., 8 to 16 carbons, 10 to 18 carbons, 10 to 16 carbons, 12 to 18 carbons, 12 to 16 carbons, such as C₈ alkyl, C₉ alkyl, C₁₀ alkyl, C₁₁ alkyl, C₁₂ alkyl, C₁₃ alkyl, C₁₄ alkyl, C₁₅ alkyl, C₁₆ alkyl, C₁₇ alkyl, or C₁₈ alkyl). In some aspects, the cation X⁺ can be a Group I cation, such as sodium cation or potassium cation, particularly sodium cation. In some aspects, the AES is sodium laureth sulfate (i.e., sodium lauryl ether sulfate). In some aspects, the AES is sodium laureth sulfate having three ethoxylate groups (SLES, 3 EO).

In some aspects, the liquid detergent composition comprises from about 1 wt % to about 5 wt % of an anionic surfactant relative to the total weight of the detergent composition. For example, the total anionic surfactant content can be from about 1 wt % to about 4.5 wt %, from about 1 wt % to about 4 wt %, from about 1 wt % to about 3.5 wt %, from about 1 wt % to about 3 wt %, from about 1 wt % to about 2.5 wt %, from about 1 wt % to about 2 wt %, from about 1 wt % to about 1.5 wt %, about 1 wt %, about 1.5 wt %, about 2 wt %, about 2.5 wt %, about 3 wt %, about 3.5 wt %, about 4 wt %, about 4.5 wt %, or about 5 wt %, of the total weight of the detergent composition. In some aspects, the detergent composition comprises from about 3 wt % to about 5 wt % of an anionic surfactant (e.g., an alkyl ether sulfate (AES)). In some aspects, the detergent composition does not comprise an anionic surfactant.

In some aspects, the liquid detergent composition does not comprise or is substantially free of a linear alkylbenzene sulfonate (LAS). LAS has the structure of Formula (I).

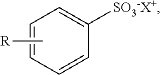

in which R is a linear C₁₀-C₁₈ (e.g., C₁₀, C₁₁, C₁₂, C₁₃, C₁₄, C₁₅, C₁₆, C₁₇, and C₁₈) alkyl, and X⁺ is a cation that balances the charge of the sulfonate. The phenylsulfonate can be at any suitable position (e.g., at the 1-position, 2-position, 3-position, 4-position, 5-position, 6-position, 7-position, 8-position, or 9-position) on the alkyl R. With respect to the benzene ring, the alkyl R and sulfonate can be ortho, meta, or para to each other. In some aspects, the alkyl R and sulfonate are para to one another.

A nonionic surfactant comprises a hydrophobic tail group (e.g., a linear aliphatic chain) and an uncharged (i.e., neutral) hydrophilic head group. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl) or alkyl. The uncharged hydrophilic group can be, for example, an alkoxylate, such as ethoxylate ((—CH₂CH₂O—)ₙ; EO or PEO) or propoxylate ((—CH(CH₃)CH₂O—)ₘ; PO or PPO), in which n and m are the same or different and each is an integer of 1 to 100 (e.g., 1 to 90, 1 to 80, 1 to 70, 1 to 60, 1 to 50, 1 to 40, 1 to 30, 1 to 20, 1 to 15, 1 to 14, 1 to 13, to 13, 1 to 12, 1 to 11, 1 to 10, 1 to 9, 1 to 8, 1 to 7, 1 to 6, 1 to 5, or 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100).

In some aspects, the nonionic surfactant comprises a methyl ester ethoxylate, an alcohol alkoxylate, a fatty acid alkoxylate, an alkyl phenol ethoxylate, an alkoxylated amine, an alkyl glucoside, a fatty amide alkoxylate, a diester of alkoxylated fatty acid, a glycerol fatty ester, castor oil alkoxylate, an ethylene oxide-propylene oxide block copolymer, a phenol alkoxylate, or a combination thereof.

Examples of an alcohol alkoxylate include, e.g., C₈-C₁₈ ethoxylate and C₈-C₁₈ propoxylate.

In general, the alcohol ethoxylate (AE) will have a chemical structure of formula (I):

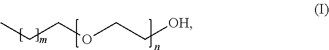

in which m is an integer of 10 to 16 (e.g., 10, 11, 12, 13, 14, 15, or 16) to form a C₁₂-C₁₈ fatty alkyl (e.g., C₁₂, C₁₃, C₁₄, C₁₅, C₁₆, C₁₇, and C₁₈), and n is an integer of 1 to 15 (e.g., 1, 2, 3, 4, 5, 6, 7, 8, 9, 10, 11, 12, 13, 14, or 15). The alcohol ethoxylate typically will contain a range of alkyl groups, such as C₁₂-C₁₅ or C₁₂-C₁₄ and can contain branches. In some aspects, the fatty alcohol ethoxylate can contain 1 to 15 moles (e.g., 1 to 12 moles, 1 to 9 moles, 1 to 7 moles, or about 7 moles) of ethoxylate per mole of alcohol. In some aspects, the fatty alcohol ethoxylate can be a C₁₂-C₁₈ fatty alcohol ethoxylate with 1-15 moles of ethoxylate. In some aspects, the fatty alcohol ethoxylate comprises a C₁₂-C₁₅ fatty alcohol ethoxylate with 7 moles of ethoxylate. In some aspects, the alcohol ethoxylate comprises ethoxylated lauryl alcohol. In some aspects, the alcohol ethoxylate comprises ethoxylated lauryl alcohol with 7 moles of ethoxylate.

In some aspects, the liquid detergent composition comprises from about 10 wt % to about 30 wt % of a nonionic surfactant (e.g., an alcohol ethoxylate (AE)), relative to the total weight of the detergent composition. For example, the total non-ionic surfactant content can be from about 10 wt % to about 29 wt %, from about 10 wt % to about 28 wt %, about 10 wt % to about 27 wt %, about 10 wt % to about 26 wt %, from about 10 wt % to about 25 wt %, from about 10 wt % to about 24 wt %, from about 10 wt % to about 23 wt %, from about 10 wt % to about 22 wt %, from about 10 wt % to about 21 wt %, from about 10 wt % to about 20 wt %, from about 10 wt % to about 19 wt %, about 10 wt % to about 18 wt %, about 10 wt % to about 17 wt %, about 10 wt % to about 16 wt %, about 10 wt % to about 15 wt %, about 10 wt % to about 14 wt %, about 10 wt % to about 13 wt %, about 10 wt % to about 12 wt %, about 10 wt % to about 11 wt %, about 11 wt % to about 20 wt % about 11 wt % to about 19 wt %, about 11 wt % to about 18 wt %, about 11 wt % to about 17 wt %, about 11 wt % to about 16 wt %, about 11 wt % to about 15 wt %, about 11 wt % to about 14 wt %, about 11 wt % to about 13 wt %, about 11 wt % to about 12 wt %, about 12 wt % to about 20 wt % about 12 wt % to about 19 wt %, about 12 wt % to about 18 wt %, about 12 wt % to about 17 wt %, about 12 wt % to about 16 wt %, about 12 wt % to about 15 wt %, about 12 wt % to about 14 wt %, about 12 wt % to about 13 wt %, about 30 wt %, about 29 wt %, about 28 wt %, about 27 wt %, about 26 wt %, about 25 wt %, about 24 wt %, about 23 wt %, about 22 wt %, about 21 wt %, about 20 wt %, about 19 wt %, about 18 wt %, about 17 wt %, about 16 wt %, about 15 wt %, about 14 wt %, about 13 wt %, about 12 wt %, about 11 wt % or about 10 wt %, of the total weight of the detergent composition. In some aspects, the detergent composition comprises about 10 to about 20 wt % of a non-ionic surfactant. In some aspects, the detergent composition comprises about 20 to about 25 wt % of a non-ionic surfactant (e.g., a non-ionic alcohol ethoxylate (AE)).

In some aspects, the liquid detergent composition comprises an alcohol ethoxylate (AE). In some aspects, the liquid detergent composition comprises an alcohol ethoxylate (AE) and an alkyl ether sulfate (AES). In some aspects, the detergent composition comprises an alcohol ethoxylate (AE), an alkyl ether sulfate (AES), and does not comprise (e.g., is substantially free of) a linear alkylbenzene sulfonate.

In some aspects, the liquid detergent composition comprises from about 3 wt % to about 30 wt % a surfactant comprising a non-ionic surfactant and/or an anionic surfactant (e.g. total surfactant). In some aspects the liquid detergent composition comprises a total surfactant in an amount of from about 3 wt % to about 29 wt %, about 3 wt % to about 28 wt %, about 3 wt % to about 26 wt %, about 3 wt % to about 24 wt %, about 3 wt % to about 22 wt %, about 3 wt % to about 20 wt %, about 3 wt % to about 18 wt %, about 3 wt % to about 16 wt %, about 3 wt % to about 14 wt %, about 3 wt % to about 12 wt %, about 3 wt % to about 10 wt %, about 10 wt % to about 30 wt %, about 15 wt % to about 30 wt %, about 20 wt % to about 30 wt %, about 5 wt %, about 10 wt %, about 15 wt %, about 20 wt %, about 25 wt %, or about 30 wt % of the total weight of the detergent composition. In some aspects, the detergent composition comprises from about 4 wt % to about 30 wt % a surfactant comprising a non-ionic surfactant and/or an anionic surfactant. In some aspects, the detergent composition comprises from about 4 wt % to about 30 wt % of a surfactant comprising a non-ionic surfactant and an anionic surfactant. In some aspects, the detergent composition comprises from about 25 wt % to about 30 wt % of a surfactant comprising a non-ionic surfactant and an anionic surfactant.

In some aspects, the non-ionic surfactant and anionic surfactant are present in an amount ratio (w/w) of about 4:1 to about 9:1. For example, the non-ionic surfactant and anionic surfactant can be present in a ratio of about 4:1 to about 9:1, about 5:1 to about 9:1, about 6:1 to about 9:1, about 7:1 to about 9:1, about 8:1 to about 9:1, about 4:1, about 5:1, about 6:1, about 7:1, about 8:1, or about 9:1. In some aspects, the non-ionic surfactant and anionic surfactant are present in an amount ratio of about 7:1. In some aspects, the non-ionic surfactant and anionic surfactant are present in an amount ratio of about 5:1. In some aspects, the non-ionic surfactant and anionic surfactant are present in an amount ratio of about 4:1.

In some aspects, the detergent composition comprises a fatty acid. In some aspects, the fatty acid is palm kernel fatty acid, coconut fatty acid, and combinations thereof. In some aspects, the fatty acid is palm kernel fatty acid. In some aspects, the fatty acid is coconut fatty acid.

In some aspects, the liquid detergent composition comprises from about 5 wt % to about 10 wt % of a fatty acid relative to the total weight of the detergent composition. For example, the fatty acid can be from about 5 wt % to about 9 wt %, about 5 wt % to about 8 wt %, about 5 wt % to about 7 wt %, from about 5 wt % to about 6 wt %, about 5 wt %, about 6 wt %, about 7 wt %, about 8 wt %, about 9 wt %, or about 10 wt % of the total weight of the detergent composition. In some aspects, the detergent composition comprises about 5 wt % to about 7 wt % of a fatty acid (e.g., palm kernel fatty acid) relative to the total weight of the detergent composition. In some aspects, the detergent composition comprises about 6 wt % of a fatty acid (e.g., palm kernel fatty acid).

In some aspects, the liquid detergent composition further comprises at least one additive. For example, the at least one additive can be selected from one or more enzymes, a chelating agent, a polymer (e.g., an anti-redeposition agent polymer and/or a performance polymer), a salt, a dye, a fragrance, an opacifier, a bittering agent, and combinations thereof.

In some aspects, the liquid detergent composition comprises from about 1 wt % to about 20 wt % of a total amount of additives relative to the total weight of the detergent composition. For example, the total amount of additives can be from about 1 wt % to about 18 wt %, about 1 wt % to about 15 wt %, about 1 wt % to about 12 wt %, about 1 wt % to about 10 wt %, about 1 wt % to about 8 wt %, about 1 wt % to about 5 wt %, about 1 wt % to about 3 wt %, about 1.5 wt % to about 20 wt %, about 1.5 wt % to about 18 wt %, about 1.5 wt % to about 15 wt %, about 1.5 wt % to about 12 wt %, about 1.5 wt % to about 10 wt %, about 1.5 wt % to about 8 wt %, about 1.5 wt % to about 5 wt %, about 1.5 wt % to about 3 wt %, about 2 wt % to about 20 wt %, about 2 wt % to about 18 wt %, about 2 wt % to about 15 wt %, about 2 wt % to about 12 wt %, about 2 wt % to about 10 wt %, about 2 wt % to about 8 wt %, about 2 wt % to about 5 wt %, about 2 wt % to about 3 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, about 10 wt %, about 10.5 wt %, about 11 wt %, about 11.5 wt %, about 12 wt %, about 12.5 wt %, about 13 wt %, about 13.5 wt %, about 14 wt %, about 14.5 wt %, about 15 wt %, about 15.5 wt %, about 16 wt %, about 16.5 wt %, about 17 wt %, about 17.5 wt %, about 18 wt %, about 18.5 wt %, about 19 wt %, about 19.5 wt %, or about 20 wt % of the total weight of the detergent composition.

In some aspects, the detergent composition comprises an enzyme to aid in removing stains, including protein stains, oil stains, tannin stains, starch stains, and dyes. For example, a protease is capable of breaking down protein-based stains, such as sweat, blood, mud, and dairy products. An amylase is capable of breaking down a starch-based stain, such as cornstarch or potato starch. A lipase is capable of breaking down fats. A mannanase is capable of breaking down guar and locust bean stains. In some aspects, the at least one enzyme is a hydrolytic enzyme. The at least one enzyme can comprise a protease, an amylase, a mannanase, a lactase, a lipase, a perhydrolase, an oxidoreductase, an endocellulase, an exocellulase, or a combination thereof. In some aspects, the detergent composition comprises a protease, an amylase, a mannanase, or a combination thereof.

In some aspects, the detergent composition comprises at least about 0.1 wt % enzyme (e.g., a protease, an amylase, a mannanase, or a combination thereof). In some aspects, the detergent composition comprises a total from about 0.01 wt % to about 5 wt % of at least one enzyme (e.g., a protease, an amylase, a mannanase, or a combination thereof) relative to the total weight of the composition. For example, the total enzyme content can from about 0.01 wt % to about 4 wt %, about 0.01 wt % to about 3 wt %, about 0.01 wt % to about 2 wt %, about 0.01 wt % to about 1 wt %, about 0.05 wt % to about 5 wt %, about 0.05 wt % to about 4 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.5 wt % to about 5 wt %, about 0.5 wt % to about 3 wt %, about 0.5 wt % to about 2 wt %, about 0.5 wt % to about 1 wt %, about 1 wt % to about 5 wt %, about 1 wt % to about 4 wt %, about 1 wt % to about 3 wt %, about 1 wt % to about 2 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4 wt %, about 4.2 wt %, about 4.5 wt %, about 4.8 wt %, or about 5 wt % of the total weight of the composition. In some aspects, the detergent composition comprises a total from about 0.5 wt % to about 3 wt % of at least one enzyme (e.g., a protease, an amylase, a mannanase, or a combination thereof) relative to the total weight of the composition.

In some aspects, the liquid detergent composition comprises a chelating agent (i.e., a chelant) that serves to improve the cleaning action of the detergent by scavenging metal ions naturally found in water. Suitable examples of a chelating agent includes, e.g., methylglycinediacetic acid (MGDA), citric acid, oxalic acid, nitriloacetic acid, phosphoric acid, polyphosphoric acid (e.g., a polyphosphate, such as tripolyphosphate), a phosphonate, ethylenediaminetetraacetic acid, diethylenetriaminepentaacetic acid (pentetic acid), hydroxyethylethylenediaminetriacetic acid, ethylenediamine-N,N′-disuccinic acid (EDDS), glutamic acid, aspartic acid, iminodisuccinic acid, any salt thereof (e.g., sodium citrate, disodium edetate, tetrasodium glutamate diacetate, tetrasodium aspartate diacetate, tetrasodium iminodisuccinate (IDS)), or any combination thereof. In some aspects, the detergent composition comprises tetrasodium iminodisuccinate.

In some aspects, the liquid detergent composition comprises from about 0.001 wt % to about 2 wt % of a chelating agent relative to the total weight of the detergent composition. For example, the chelating agent can be present in an amount from about 0.001 wt % to about 2 wt %, about 0.001 wt % to about 1.9 wt %, about 0.001 wt % to about 1.8 wt %, about 0.001 wt % to about 1.7 wt %, about 0.001 wt % to about 1.6 wt %, about 0.001 wt % to about 1.5 wt %, about 0.001 wt % to about 1.4 wt %, about 0.001 wt % to about 1.3 wt %, about 0.001 wt % to about 1.2 wt %, about 0.001 wt % to about 1.1 wt %, from about 0.001 wt % to about 1 wt %, about 0.001 wt % to about 0.9 wt %, about 0.001 wt % to about 0.8 wt %, about 0.001 wt % to about 0.7 wt %, about 0.001 wt % to about 0.6 wt %, about 0.001 wt % to about 0.5 wt %, about 0.001 wt % to about 0.4 wt %, about 0.001 wt % to about 0.3 wt %, about 0.001 wt % to about 0.2 wt %, about 0.001 wt % to about 0.1 wt %, about 0.001 wt % to about 0.09 wt %, about 0.001 wt % to about 0.08 wt %, about 0.001 wt % to about 0.07 wt %, about 0.001 wt % to about 0.06 wt %, about 0.001 wt % to about 0.05 wt %, about 0.001 wt % to about 0.04 wt %, about 0.001 wt % to about 0.03 wt %, about 0.001 wt % to about 0.02 wt %, about 0.001 wt % to about 0.01 wt %, about 0.001 wt % to about 0.009 wt %, about 0.001 wt % to about 0.008 wt %, about 0.001 wt % to about 0.007 wt %, about 0.001 wt % to about 0.006 wt %, about 0.001 wt % to about 0.005 wt %, about 0.001 wt % to about 0.004 wt %, about 0.001 wt % to about 0.003 wt %, or about 0.001 wt % to about 0.002 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, or about 1 wt %, of the total weight of the detergent composition. In some aspects, the detergent composition comprises from about 0.1 wt % to about 1 wt % of a chelating agent (e.g., tetrasodium iminodisuccinate). In some aspects, the detergent composition comprises about 1 wt % of a chelating agent (e.g., tetrasodium iminodisuccinate).

In some aspects, the detergent composition comprises a performance polymer that improves at least one aspect of a washed textile. In some aspects, the performance polymer improves the cleaning action of the detergent composition, removes or reduces stains, maintains whiteness, protects color, protects the integrity of a textile, provides odor control, or any combination thereof. In some aspects the performance polymer comprises polyethyleneimine ethoxylate, polyethyleneimine ethoxylate propoxylate, a polycarboxylate (e.g., an acrylic homopolymer or copolymer), carboxymethylcellulose, a polyester, polyvinyl pyrrolidone, a copolymer comprising terephthalic acid, a copolymer comprising maleic acid, a copolymer comprising acylamino tertiary butyl sulfonate, or any combination thereof. In some aspects the performance polymer comprises an alkoxylated polyethyleneimine, such as polyethyleneimine ethoxylate, polyethyleneimine propoxylate, polyethyleneimine ethoxylate propoxylate, or a combination thereof.

In some aspects, the detergent composition comprises from about 0.001 wt % to about 5 wt % of a performance polymer relative to the total weight of the detergent composition. For example, the performance polymer can be from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the detergent composition. In some aspects, the detergent composition comprises from about 0.1 wt % to about 2 wt % of a performance polymer (e.g., an alkoxylated polyethyleneimine).

In some aspects, the liquid detergent composition comprises an anti-redeposition agent that keeps dissolved soil stains stable in the wash water and prevent the stains from redepositing on a textile. In some aspects, the anti-redeposition agent is a biodegradable polymer. The anti-redeposition agent (e.g., anti-redeposition polymer) can be based on acrylic acid, e.g., a homopolymer of acrylic acid, a polycarboxylate based on acrylic acid, a copolymer of acrylic acid and polystyrene, or a copolymer of maleic acid and acrylic acid. Examples of a suitable anti-redeposition agent include, e.g., sodium polyacrylate, modified polyethylene glycol, styrene-acrylic acid copolymer, polyethyleneimine, or a combination thereof. In some aspects, the anti-redeposition agent comprises sodium polyacrylate.

In some aspects, the detergent composition can comprise a bitterant (e.g., a bittering agent), which is any suitable compound that imparts a bitter taste to the composition. The bitterant can be added to avoid accidental poisoning. Examples of the bitterant include, e.g., denatonium benzoate, sucrose octaacetate, quercetin, brucine, quassin, and combinations thereof. In an aspect, the bitterant is denatonium benzoate.

In some aspects, the detergent composition can comprise from about 0.001 wt % to about 1 wt % of a bitterant relative to the total weight of the composition. For example, the bitterant can be present in an amount from about 0.001 wt % to about 0.9 wt %, about 0.001 wt % to about 0.8 wt %, about 0.001 wt % to about 0.7 wt %, about 0.001 wt % to about 0.5 wt %, about 0.005 wt % to about 1 wt %, about 0.005 wt % to about 0.9 wt %, about 0.005 wt % to about 0.8 wt %, about 0.005 wt % to about 0.6 wt %, about 0.005 wt % to about 0.5 wt %, about 0.01 wt % to about 1 wt %, about 0.01 wt % to about 0.9 wt %, about 0.01 wt % to about 0.8 wt %, about 0.01 wt % to about 0.7 wt %, about 0.05 wt % to about 0.6 wt %, about 0.05 wt % to about 0.5 wt %, about 0.05 wt % to about 0.2 wt %, about 0.05 wt % to about 0.1 wt %, about 0.1 wt % to about 1 wt %, about 0.1 wt % to about 0.9 wt %, about 0.1 wt % to about 0.8 wt %, about 0.1 wt % to about 0.5 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, or about 1 wt % of the total weight of the composition. In some aspects, the detergent composition comprises about 0.05 wt % of a bitterant. In some aspects, the water-soluble film comprises about 0.05 wt % of a bittering agent.

In some aspects, the liquid detergent composition comprises one or more enzymes, a chelating agent, a polymer, a salt, a bittering agent, and combinations thereof. In some aspects, the detergent composition comprises one or more enzymes, a chelating agent, a polymer, and a bittering agent as additives. In some aspects, the detergent composition comprises a protease and a mannase, IDS, an alkoxylated polyethyleneimine, and denatonium benzoate as additives.

In some aspects, the unit dose product comprises a water-soluble film and a liquid detergent composition, the liquid detergent composition comprising a surfactant comprising a non-ionic surfactant and/or an anionic surfactant; a non-aqueous solvent; sodium hydroxide; a fatty acid; and water, wherein the liquid detergent composition is substantially free of monoethanolamine, sodium sulfite, and linear alkyl benzene sulfonate, wherein the liquid detergent composition is encapsulated in the water-soluble film material, and wherein the unit dose product exhibits a Pantone color ranking of 1 or less after one week at a temperature of about 40 °F.

In some aspects, the unit dose product comprises a water-soluble film and a liquid detergent composition, the liquid detergent composition comprising about 4 wt % to about 30 wt % of a surfactant comprising a non-ionic surfactant and/or an anionic surfactant; a non-aqueous solvent; sodium hydroxide; a fatty acid; and water, wherein when the anionic surfactant is present, the non-ionic and anionic surfactant are present in a ratio of about 4:1 to about 9:1, wherein the liquid detergent composition is substantially free of monoethanolamine, sodium sulfite, and linear alkyl benzene sulfonate, wherein the liquid detergent composition is encapsulated in the water-soluble film material, and wherein the unit dose product exhibits a Pantone color ranking of 1 or less after one week at a temperature of about 40 °F.

In some aspects, the unit dose product comprises a water-soluble film and a liquid detergent composition, the liquid detergent composition comprising about 20 wt % to about 30 wt % of a surfactant comprising a non-ionic surfactant and an anionic surfactant in a ratio of about 4:1 to about 9:1; a non-aqueous solvent selected from the group consisting of glycerin, ethanol, polyethylene glycol, and combinations thereof; sodium hydroxide; a fatty acid; and water, wherein the liquid detergent composition is substantially free of monoethanolamine, sodium sulfite, and linear alkyl benzene sulfonate, wherein the liquid detergent composition is encapsulated in the water-soluble film material, and wherein the unit dose product exhibits a Pantone color ranking of 1 or less after one week at a temperature of about 40 °F.

In some aspects, the unit dose product comprises a water-soluble film and a liquid detergent composition, the liquid detergent composition comprising about 20 wt % to about 30 wt % of a surfactant comprising a non-ionic surfactant and an anionic surfactant in a ratio of about 4:1 to about 9:1; about 40 wt % to about 50 wt % of a non-aqueous solvent selected from the group consisting of glycerin, ethanol, polyethylene glycol, and combinations thereof; sodium hydroxide; a fatty acid; and water, wherein the liquid detergent composition is substantially free of monoethanolamine, sodium sulfite, and linear alkyl benzene sulfonate, wherein the liquid detergent composition is encapsulated in the water-soluble film material, and wherein the unit dose product exhibits a Pantone color ranking of 1 or less after one week at a temperature of about 40 °F.

In some aspects, the unit dose product comprises a water-soluble film and a liquid detergent composition, the liquid detergent composition comprising about 20 wt % to about 30 wt % of a surfactant comprising a non-ionic surfactant and an anionic surfactant in a ratio of about 4:1 to about 9:1; about 40 wt % to about 50 wt % of a non-aqueous solvent selected from the group consisting of glycerin, ethanol, polyethylene glycol, and combinations thereof; about 1 wt % to about 2 wt % of sodium hydroxide; a fatty acid; and water, wherein the liquid detergent composition is substantially free of monoethanolamine, sodium sulfite, and linear alkyl benzene sulfonate, wherein the liquid detergent composition is encapsulated in the water-soluble film material, and wherein the unit dose product exhibits a Pantone color ranking of 1 or less after one week at a temperature of about 40 °F.

In some aspects, the unit dose product comprises a water-soluble film material and a liquid detergent composition, the liquid detergent composition comprising: about 25 wt % to about 30 wt % of a surfactant comprising a non-ionic surfactant and an anionic surfactant in a ratio of about 4:1 to about 9:1; about 45 wt % to about 50 wt % of a non-aqueous solvent selected from the group consisting of glycerin, ethanol, polyethylene glycol, and combinations thereof; about 1 wt % to about 2 wt % of sodium hydroxide; about 5 wt % to about 7 wt % of a fatty acid; and water, wherein the liquid detergent composition is substantially free of monoethanolamine, sodium sulfite, and linear alkyl benzene sulfonate, wherein the liquid detergent composition is encapsulated in the water-soluble film material, and wherein the unit dose product exhibits a Pantone color ranking of 1 or less after one week at a temperature of about 40 °F.

In some aspects, the unit dose product comprises a water-soluble film material and a liquid detergent composition, the liquid detergent composition comprising: about 25 wt % to about 30 wt % of a surfactant comprising a non-ionic surfactant and an anionic surfactant in a ratio of about 4:1 to about 9:1; about 45 wt % to about 50 wt % of a non-aqueous solvent selected from the group consisting of glycerin, ethanol, polyethylene glycol, and combinations thereof; about 1 wt % to about 2 wt % of sodium hydroxide; about 5 wt % to about 7 wt % of a fatty acid; water; one or more enzymes; a chelating agent; and a bitterant, wherein the liquid detergent composition is substantially free of monoethanolamine, sodium sulfite, and linear alkyl benzene sulfonate, wherein the liquid detergent composition is encapsulated in the water-soluble film material, and wherein the unit dose product exhibits a Pantone color ranking of 1 or less after one week at a temperature of about 40 °F.

In some aspects, the unit dose product comprises a water-soluble film material and a liquid detergent composition, the liquid detergent composition consisting of: about 4 wt % to about 30 wt % of a surfactant comprising a non-ionic surfactant; about 35 wt % to about 50 wt % of a non-aqueous solvent; about 0.1 wt % to about 3 wt % of sodium hydroxide; about 3 wt % to about 8 wt % of a fatty acid; about 5 wt % to about 15 wt % of water; about 0.5 wt % to about 3 wt % of a polymer, about 0.5 to 2 wt % of one or more enzymes; about 0.1 to about 2 wt % of a chelating agent; and about 0.1 to about 1 wt % of a bitterant, wherein the liquid detergent composition is encapsulated in the water-soluble film material, wherein the unit dose product exhibits a Pantone color ranking of 1 or less after one week at a temperature of about 40 °F.

In some aspects, the unit dose product comprises a water-soluble film material and a liquid detergent composition, the liquid detergent composition consisting of: about 4 wt % to about 30 wt % of a surfactant comprising a non-ionic surfactant and an anionic surfactant in a ratio of about 4:1 to about 9:1; about 35 wt % to about 50 wt % of a non-aqueous solvent; about 0.1 wt % to about 3 wt % of sodium hydroxide; about 3 wt % to about 8 wt % of a fatty acid; about 5 wt % to about 15 wt % of water; about 0.5 wt % to about 3 wt % of a polymer, about 0.5 wt % to about 2 wt % of one or more enzymes; about 0.1 wt % to about 2 wt % of a chelating agent; and about 0.1 wt % to about 1 wt % of a bitterant, wherein the liquid detergent composition is encapsulated in the water-soluble film material, wherein the unit dose product exhibits a Pantone color ranking of 1 or less after one week at a temperature of about 40 °F.

In some aspects, the unit dose product comprises a water-soluble film material and a liquid detergent composition, the liquid detergent composition consisting of: about 25 wt % to about 30 wt % of a surfactant comprising a non-ionic surfactant and an anionic surfactant in a ratio of about 4:1 to about 9:1; about 45 wt % to about 50 wt % of a non-aqueous solvent; about 1 wt % to about 2 wt % of sodium hydroxide; about 5 wt % to about 7 wt % of a fatty acid; about 10 wt % to about 12 wt % of water; about 1 wt % to about 3 wt % of a polymer; about 0.5 wt % to about 2 wt % of one or more enzymes; about 0.5 wt % to about 2 wt % of a chelating agent; and about 0.1 wt % to about 2 wt % of a bitterant, wherein the liquid detergent composition is encapsulated in the water-soluble film material, wherein the unit dose product exhibits a Pantone color ranking of 1 or less after one week at a temperature of about 40 °F.

In some aspects, the unit dose product comprises a water-soluble film material and a liquid detergent composition, the liquid detergent composition consisting essentially of: a non-ionic surfactant; a non-aqueous solvent consisting of a combination of glycerin, ethanol, and polyethylene glycol; sodium hydroxide; a fatty acid; water; a polymer; two enzymes; a chelating agent; and a bitterant, wherein the liquid detergent composition is encapsulated in the water-soluble film material, wherein the unit dose product exhibits a Pantone color ranking of 1 or less after one week at a temperature of about 40 °F.

In some aspects, the unit dose product comprises a water-soluble film material and a liquid detergent composition, the liquid detergent composition consisting essentially of: a non-ionic surfactant and an anionic surfactant; a non-aqueous solvent consisting of a combination of glycerin, ethanol, and polyethylene glycol; sodium hydroxide; a fatty acid; water; a polymer; two enzymes; a chelating agent; and a bitterant, wherein the liquid detergent composition is encapsulated in the water-soluble film material, wherein the unit dose product exhibits a Pantone color ranking of 1 or less after one week at a temperature of about 40 °F.

The detergent composition is encapsulated (e.g., enclosed) within a water-soluble film pouch to form of a unit dose product (e.g., a detergent pack). As used herein, the term “water-soluble” means that least 2 grams of the solute (e.g., the film) dissolves in 5 liters of solvent (e.g., water) for a solubility of at least 0.4 grams per liter (g/l) at a temperature of 25 °C unless otherwise specified. Upon contact with water (e.g., water in the wash cycle in a method of washing), the water-soluble film will release the detergent composition.

In some aspects, the unit dose product comprises about 15 to about 25 grams of the liquid detergent composition. For example, the unit dose product can comprise from about 15 grams to about 25 grams, about 15 grams to about 24.5 grams, about 15 grams to about 24 grams, about 15 grams to about 23.5 grams, about 15 grams to about 23 grams, about 15 grams to about 22.5 grams, about 15 grams to about 22 grams, about 15 grams to about 21.5 grams, about 15 grams to about 21 grams, about 15 grams to about 20.5 grams, about 15 grams to about 20 grams, about 15 grams to about 19.5 grams, about 15 grams to about 19 grams, about 15 grams to about 18.5 grams, about 15 grams to about 18 grams, about 15 grams to about 17.5 grams, about 15 grams to about 17 grams, about 15 grams to about 16.5 grams, about 15 grams to about 16 grams, about 15 grams to about 15.5 grams, about 15 grams, about 16 grams, about 17 grams, about 18 grams, about 19 grams, about 20 grams, about 21 grams, about 22 grams, about 23 grams, about 24 grams, or about 25 grams, of the the liquid detergent composition. In some aspects, the unit dose product comprises about 15 to about 24 grams of the liquid detergent composition. In some aspects, the unit dose product comprises about 18 to about 19 grams of the liquid detergent composition.

The pouch can be a single compartment, and the detergent composition is releasably disposed within the single compartment. Alternatively, the pouch can have two or more (e.g., 2, 3, or 4) compartments that are sealed off from one another, and the detergent composition is releasably disposed within at least one of the two or more compartments. In some aspects, the same detergent composition is present in each compartment of the pouch. In some aspects, the other compartment(s) can include colorants or other components, such as an alternative composition in the form of solid or liquid. In some aspects, the solid composition is a powder, granule, tablet, or combinations thereof. In some aspects, the alternative composition comprises a rinse aid or a fabric softener. In some aspects, different film compositions can be used to form different sections or compartments of the pouch. For example, different films can dissolve at different rates to provide timed release of the compartments' contents.

The sealing of a water-soluble film material (e.g., in the form of one or two sheets) to form a compartment can be performed using methods known to those of skill in the art. In some aspects, the water-soluble film material is sealed using heat-sealing, solvent sealing, or ultraviolet (UV) sealing. In some aspects, the water-soluble film material sealed using water sealing.

The unit dose product (e.g., pouch or detergent pack) can be in any suitable shape and size, e.g., square, rectangular, oval, ellipsoid, super elliptical, or circular shape. In general, the size and shape of the pouch is large enough to enclose (e.g., entrap) about 15 g to about 30 g total weight of the detergent composition.

The water-soluble film is desirably strong, flexible, shock resistant, and non-tacky during storage at both high and low temperatures and high and low humidities. Non-limiting examples of suitable materials for the water-soluble film include, e.g., polyvinyl alcohol (PVOH), polyvinyl acetate (PVA), film-forming cellulosic polymers, polyacrylic acid, polyacrylamide, polyanhydride, a polysaccharide, and combinations thereof. Examples of film-forming cellulosic polymer include, e.g., cellulose, cellulose ether, cellulose ester, cellulose amide, methylcellulose, carboxymethylcellulose sodium, ethylcellulose, hydroxyethyl cellulose, hydroxypropyl methyl cellulose (HPMC), and combinations thereof. Unit dose detergent packs, including water-soluble films, are described in U.S. Pat. Nos. 8,551,929, 10,774,294, and 11,492,574, the disclosures of which are incorporated herein by reference in their entirety. In some aspects, the water-soluble film material comprises polyvinyl alcohol (PVOH) or polyvinyl acetate (PVA).

In an aspect, the water-soluble film material is polyvinyl alcohol (PVOH). In some aspects, the PVOH can have a number average molecular weight range of about 10,000 to about 100,000 g/mol (e.g., about 10,000 to about 80,000 g/mol, about 15,000 to about 60,000 g/mol, about 20,000 to about 50,000 g/mol, about 25,000 to about 40,000 g/mol, or about 27,000 to about 33,000).

In some aspects, the film material comprises a bitterant (e.g., denatonium benzoate) as described herein, to impart a bitter taste to help avoid accidental poisoning.

In some aspects, the film material can have a thickness of about 10 to about 100 μm (e.g., about 10 to 90 μm, about 20 to about 80 μm, about 50 to about 100 μm, about 50 to about 80 μm, about 70 to about 80 μm, about 100 μm, about 95 μm, about 90 μm, about 85 μm, about 80 μm, about 75 μm, about 70 μm, about 65 μm, about 60 μm, about 55 μm, about 50 μm, about 45 μm, about 40 μm, about 35 μm, about 30 μm, about 25 μm, about 20 μm, about 15 μm, or about 10 μm). In some aspects, the film material will have a thickness of about 75 μm.

In some aspects, the present disclosure is directed to a method of using the unit dose product of any of the foregoing aspects. For example, the unit dose product can be used in a method of removing soil from a textile (e.g., cleaning a textile, such as a fabric). In particular, the present disclosure is directed to a method of removing soil from a textile comprising contacting the textile with a unit dose comprising the detergent composition described herein and water to form a washing load. Optional steps include mixing (e.g., agitating) the washing load and composition, removing the composition to provide a clean textile, rinsing the clean textile with additional water, and isolating the clean textile. In some aspects, soils that are suitably removed using the unit dose product include, but are not limited to, oil-containing soils, carbohydrate-containing soils, protein-containing soils, tannin-containing soils, particulate soils, and any combination thereof.

In some aspects of these methods, the method can be performed using a washing machine, a tergotometer, or an equivalent device. In some aspects of these methods, the water is hot or warm water (e.g., about 70-95 °F, about 71-90 °F, about 77-95 °F, about 77-90 °F, about 82-95 °F, about 86-95 °F, or about 90 °F). In some aspects of these methods, the water is cold water (e.g., about 50-68 °F, about 54-60 °F, or about 41 °F).

In an aspect, the method is directed to providing a mild detergent composition.

In an aspect, the method is directed to providing an allergen-free detergent composition.

In an aspect, the method is directed to providing detergent compositions comprising Safer Choice ingredients.

It was discovered that the following order of addition maximizes the unit dose's appearance and stability: 1) surfactant (anionic and/or non-ionic); 2) fatty acid; 3) solvent; 5) sodium hydroxide; 6) enzymes/chelants/polymers/bittering agent. In particular, the when the sodium hydroxide is added prior to the fatty acid, the fatty acid becomes unstable and form flecks in the detergent solution. This can be avoided if the fatty acid is added prior to the sodium hydroxide.

Accordingly, the present disclosure is directed to a method of preparing the liquid detergent composition of the unit dose product described herein. In some aspects, the present disclosure relates to a method of preparing a liquid detergent composition, described herein, comprising adding the fatty acid to the surfactant and/or the non-aqueous solvent before adding the sodium hydroxide.

### EXAMPLES

These examples are provided for the purpose of illustration only and the embodiments described herein should in no way be construed as being limited to these examples. Rather, the embodiments should be construed to encompass any and all variations which become evident as a result of the teaching provided herein.

### Example 1

Two exemplarily liquid detergent compositions, “Formula 1” and “Formula 2” were prepared using the components listed in Table 1.

TABLE 1

| | Formula 1 | Formula 2 |
|---|---|---|
| C12-C15 Alcohol Ethoxylate 7EO | 23.074 | 23.074 |
| SLES 70% active, 3EO | 4.800 | 4.800 |
| Fatty Acid | 6.000 | 6.000 |
| Glycerin | 22.926 | 23.226 |
| Demineralized Water | 11.000 | 11.000 |
| Ethanol (200 Proof) | 3.000 | 3.000 |
| PEG 400 | 23.000 | 23.000 |
| Monoethanolamine | | 1.000 |
| NaOH 50% | 1.300 | |
| Enzymes, Performance Polymer, | 4.9 | 4.9 |
| Chelant (IDS), Bitterant | | |
| Total | 100.000 | 100.000 |

SLES: sodium lauryl ether sulfate
EO: ethoxylate
IDS: iminodisuccinic acid

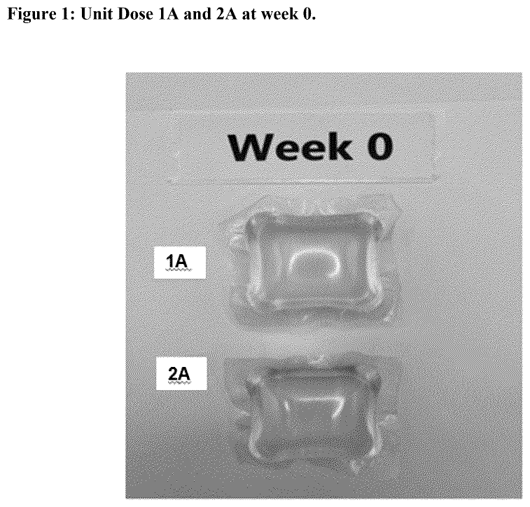

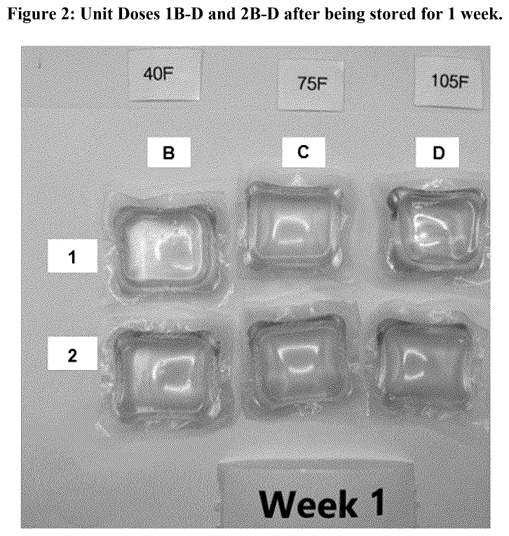

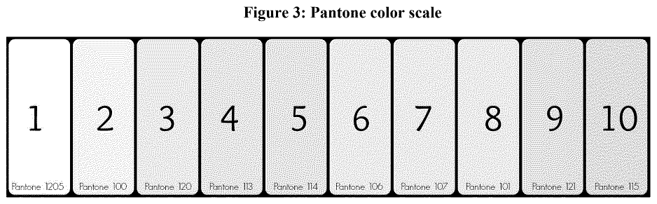

Four unit doses enclosing Formula 1 were prepared, resulting in unit doses 1A-D. Similarly, four unit doses enclosing Formula 2 were also prepared, resulting in unit doses 2A-D. The resulting eight unit doses were then analyzed for yellowing at time 0 (shown in FIG. 1) and after one week of being stored at a temperatures of 40 °F (1B and 2B), 75 °F (1C and 2C), and 105 °F (1D and 2D). After one week, the unit dose packs were photographed (FIG. 2) and scored on a Pantone color scale as shown in FIG. 3. The resulting Pantone color scores are shown below in Table 2.

TABLE 2

Pantone Color Ranking (0-10)*

| | “A” | | | |
|---|---|---|---|---|
| Unit Dose | (Time | “B” | “C” | “D” |
| (temperature) | Zero) | (40 °F) | (75 °F) | (105 °F) |
| Formula 1 | 1 | 1 | 2 | 3 |
| Formula 2 | 3 | 4 | 6 | 8 |

*Ranking based on Pantone color scale shown in FIG. 3

As shown in FIGS. 1-2 and Table 2 above, the use of NaOH (Formula 1) instead of monoethanolamine (Formula 2) showed significant color improvement and stability in unit dose compositions after one week of being stored at temperatures 40 °F, 75 °F, and 105 °F.

### Example 2

It was observed that the fatty acid became unstable if added after sodium hydroxide, and would for flecks in the detergent solution. It was found that if the fatty acid was added prior to the sodium hydroxide, then the fatty acid remained solubilized without flecking. The optimized order of addition for preparing the liquid composition as described herein is shown below in Table 3.

TABLE 3

| Step | Component |
|---|---|
| 1. | Surfactant (anionic and/or non-ionic) |
| 2. | Fatty Acid |
| 3. | Non-aqueous solvent(s) |
| 4. | sodium hydroxide |
| 5. | Additives |

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A unit dose product comprising
a water-soluble film material and a liquid detergent composition, the liquid detergent composition comprising:
a) about 4 wt % to about 30 wt % of a surfactant comprising a non-ionic surfactant and/or an anionic surfactant;
b) a non-aqueous solvent;
c) sodium hydroxide;
d) a fatty acid; and
e) water,
wherein when the anionic surfactant is present, the non-ionic and anionic surfactant are present in a ratio of about 4:1 to about 9:1,
wherein the liquid detergent composition is substantially free of monoethanolamine, sodium sulfite, and linear alkyl benzene sulfonate,
wherein the liquid detergent composition is encapsulated in the water-soluble film material, and
wherein the unit dose product exhibits a Pantone color ranking of 1 or less after one week at a temperature of about 40 °F.

2. The unit dose product of claim 1, wherein the liquid detergent composition comprises a non-ionic surfactant and an anionic surfactant.

3. The unit dose product of claim 2, wherein the non-ionic surfactant is an alcohol ethoxylate and the anionic surfactant is an alkyl ether sulfate.

4. The unit dose product of claim 3, wherein the alcohol ethoxylate comprises the formula R¹-(EO)ₙ—OH, wherein R¹ is a C₁₂-C₁₈ alkyl group, EO is ethoxylate, and n is an integer of moles from 1 to 15, and the alkyl ether sulfate is sodium lauryl ether sulfate.

5. The unit dose product of claim 1, wherein the non-aqueous solvent is selected from the group consisting of glycerin, ethanol, polyethylene glycol, and combinations thereof.

6. The unit dose product of claim 1, wherein the fatty acid is palm kernel fatty acid.

7. The unit dose product of claim 1, wherein the liquid detergent formulation further comprises at least one additive selected from one or more enzymes, a chelating agent, a polymer, a salt, a dye, a fragrance, an opacifier, a bittering agent, and combinations thereof.

8. The unit dose product of claim 7, wherein the liquid detergent formulation further comprises one or more enzymes, a chelating agent, and a bittering agent.

9. The unit dose product of claim 8, wherein the one or more enzymes comprise a protease and a mannase, the chelating agent is iminodisuccinic acid, and the bittering agent is bitrex.

10. The unit dose product of claim 1, wherein the water-soluble film comprises a bittering agent.

11. The unit dose product of claim 1, wherein the unit dose product exhibits a Pantone color ranking of 2 or less after one week of being stored at a temperature of about 75 °F.

12. The unit dose product of claim 1, wherein the unit dose product exhibits a Pantone color ranking of 3 or less after one week of being stored at a temperature of about 105 °F.

13. The unit dose product of claim 1, wherein the unit dose product comprises about 15 to about 24 grams of the liquid detergent composition.

14. A method of preparing the liquid detergent composition of the unit dose product of claim 1 comprising adding the fatty acid to the surfactant and/or the non-aqueous solvent before adding the sodium hydroxide.

15. A unit dose product comprising
a water-soluble film material and a liquid detergent composition, the liquid detergent composition comprising
a) about 25 wt % to about 30 wt % of a surfactant comprising a non-ionic surfactant and an anionic surfactant in a ratio of about 4:1 to about 9:1;
b) about 45 wt % to about 50 wt % of a non-aqueous solvent selected from the group consisting of glycerin, ethanol, polyethylene glycol, and combinations thereof;
c) about 1 wt % to about 2 wt % of sodium hydroxide;
d) about 5 wt % to about 7 wt % of a fatty acid; and
e) water,
wherein the liquid detergent composition is substantially free of monoethanolamine, sodium sulfite, and linear alkyl benzene sulfonate,
wherein the liquid detergent composition is encapsulated in the water-soluble film material, and
wherein the unit dose product exhibits a Pantone color ranking of 1 or less after one week at a temperature of about 40 °F.

16. The unit dose product of claim 15, wherein the non-ionic surfactant is an alcohol ethoxylate and the anionic surfactant is an alkyl ether sulfate.

17. The unit dose product of claim 16, wherein the alcohol ethoxylate comprises the formula R¹-(EO)ₙ—OH, wherein R¹ is a C₁₂-C₁₈ alkyl group, EO is ethoxylate, and n is an integer of moles from 1 to 15, and the alkyl ether sulfate is sodium lauryl ether sulfate.

18. The unit dose product of claim 15, wherein the unit dose product exhibits a Pantone color ranking of 2 or less after being stored for one week at a temperature of about 75 °F.

19. The unit dose product of claim 15, wherein the unit dose product exhibits a Pantone color ranking of 3 or less after being stored for one week at a temperature of about 105 °F.

20. The unit dose product of claim 15, wherein the unit dose product comprises about 15 to about 24 grams of the liquid detergent composition.
